(19) United States
(12) Patent Application Publication
(10) Pub. No.: US 2010/0076606 A1
(43) Pub. Date: Mar. 25, 2010

(54) METHOD AND APPARATUS FOR PRODUCING A CONSTANT AIR FLOW FROM A BLOWER BY SENSING BLOWER HOUSING VACUUM

(75) Inventors: William Stuart Gatley, Cassville, MO (US); Robert E. Jones, Saint Peters, MO (US)

Correspondence Address: THOMPSON COBURN LLP, ONE US BANK PLAZA, SUITE 3500, ST LOUIS, MO, 63101, US

(73) Assignee: JAKEL INCORPORATED, AURORA, MO (US)

(21) Appl. No.: 12/376,260

(22) PCT Filed: Aug. 23, 2007
(86) PCT No.: PCT/US07/76654

§ 371 Date: Nov. 17, 2009

Related U.S. Application Data
(60) Provisional application No. 60/823,283, filed on Aug. 23, 2006.

(51) Int. Cl. G05D 23/19; G05D 7/06

(52) U.S. Cl. 700/276; 700/282

(57) ABSTRACT

An airflow control system for a blower providing the combustion air for an HVAC system comprises a single phase AC blower motor driving a blower wheel within a blower housing, a vacuum sensor mounted to the housing to sense the vacuum or pressure differential created by the blower as it operates, and a controller that receives as its only feedback signal a variable signal from the vacuum sensor which signal is proportional to the sensed vacuum within the housing and provides an output voltage to the blower motor to adjust the blower motor speed to thereby preferably produce a constant air flow.

### CROSS REFERENCE TO RELATED APPLICATION

This application claims priority to provisional application Ser. No. 60/823,283 filed Aug. 23, 2006, the disclosure of which is incorporated herein by reference.

### TECHNICAL FIELD OF THE INVENTION

The present invention relates to control of airflow, and particularly an improved controller utilizing a vacuum sensor (pressure differential sensor) to control the speed of a blower motor so that the airflow through the blower remains constant.

### BACKGROUND OF THE INVENTION

In operation, an air blower creates an air pressure differential or “vacuum” within its housing. The amount of airflow created by the blower is directly proportional to this air pressure differential. Some HVAC blowers today use brushless DC motors and their derivatives. That's because a typical brushless DC motor exhibits a linear torque (and thus current) versus speed curve, thereby making it easy for controllers for these HVAC blowers to implement constant airflow control by simply controlling the motor current. However, this type of airflow control requires coordination with other controllers in the overall HVAC system to achieve constant airflow as the actual airflow is typically affected by other parameters such as vent length, blockages in the vent, etc. Thus, these prior art controllers suffer from the increased complexity and cost required to achieve this coordination, and further are typically designed to match a particular HVAC device and installation.

### SUMMARY OF THE INVENTION

In accordance with the principles of this invention, an airflow control system preferably comprises a blower motor, a vacuum or pressure differential sensor mounted to sense the vacuum created by the blower, and an embedded controller that receives as input a signal from the vacuum sensor and provides an output voltage to control the speed of the blower motor to maintain a specific vacuum and thereby a constant air flow. Thus, the present invention uses the direct measurement of the air flow by way of the sensed vacuum within the blower housing to monitor and control the blower speed and maintain a constant air flow, or otherwise control the air flow to maximize combustion. This allows the blower to be designed as part of an HVAC system without regard to variations in installation that would have to be taken into account with prior art designs, such as vent length, and also provides reliable and efficient operation regardless of temporary conditions such as blockages in the vent. The present invention is also elegantly simpler in design and thus less expensive, having fewer components and with less need to coordinate its operation with other system components in order to achieve true constant, or controlled, air flow. In the HVAC industry it is well known that variable speed ventilator blower operation leads to improved system efficiency and that constant airflow control combined with this variable speed control enhances HVAC operating parameters such as reduced flue operating temperatures, more uniform control of CO₂, lower operating noise, insensitivity to vent lengths in draft inducers, and better climate control in ventilation blower applications. Thus, the present invention also finds a ready application to the variable speed applications as well.

In a typical installation, this constant air flow blower is used as the combustion blower, supplying air for combustion of a supply gas within a gas furnace, or HVAC unit. By providing better and more reliable control of air flow to the burner, more efficient operation of the burner is achieved and hence more efficient furnace operation, resulting in savings to the consumer.

In accordance with the principles of this invention, an airflow control system preferably comprises a blower motor mounted to drive a blower wheel contained within a housing, a vacuum switch mounted to the housing to detect the negative pressure differential drawn by the blower wheel as it rotates within the housing, the vacuum switch generating a variable voltage for feedback to an electronic control, with the electronic control generating a control voltage to vary the blower motor speed as required to maintain a relatively constant negative pressure within the blower housing and thereby a relatively constant air flow from the blower. Should the vacuum sense a pressure outside its ordinary limits, the control may be connected to a gas supply valve which it would then shut off to interrupt furnace operation until the source of the problem could be found and corrected, in order to provide a safety feature that is directly tied to air flow in the burner pathway. Due to its more direct relationship, it is thought that this safety feature is more reliable than others, and hence provides a greater safety advantage.

In accordance with one aspect of the invention, the controller preferably comprises a sensor excitation power supply to provide power to the vacuum sensor, a high frequency noise filter to reduce the noise present in the output signal of the vacuum sensor, an amplifier circuit to amplify the output signal of the high frequency noise filter and provide a vacuum feedback voltage as output, a vacuum regulator circuit that receives as inputs the vacuum feedback voltage and a vacuum set point voltage and provides an output voltage to a phase control circuit, a phase control circuit that produces a control signal for an electronic switch, and an electronic switch circuit for modulating the AC voltage applied to the blower motor.

In another aspect of the invention, the controller further comprises a start-up timing circuit.

In another aspect of the invention, the controller further comprises a vacuum alarm circuit.

In another aspect of the invention, the controller further comprises an absolute value circuit.

In another aspect of the invention, the controller of the airflow control system is cascaded with a variable speed drive.

### BRIEF DESCRIPTION OF DRAWINGS

For a better understanding of the present invention, reference may be made to the accompanying drawings in which:

FIG. 1 illustrates a block diagram of the airflow control system of the present invention;

FIG. 2 illustrates a schematic view of an airflow control system using a vacuum sensor;

FIG. 3 illustrates a schematic view of the vacuum sensor circuits;

FIG. 4 illustrates a schematic view of a phase control circuit;

FIG. 5 illustrates a schematic view of a phase controlled electronic switch;

FIG. 6 illustrates a schematic view of an AC line zero crossing detection circuit for use in the phase control circuit of FIG. 5.

FIG. 7 illustrates a schematic view of an AC/DC power conversion circuit;

FIG. 8 illustrates a schematic view of a bi-directional filter.

### DETAILED DESCRIPTION OF THE PREFERRED EMBODIMENT

In the following detailed description, numerous specific details are set forth in order to provide a thorough understanding of the inventors' best mode of the invention to one of ordinary skill in the art. However, it will be understood by those skilled in the art that the present invention may be practiced without these specific details. Instead, well-known methods, procedures, and components may be used with the present disclosure as a guide to produce other embodiments of the invention, by those of skill in the art, and all of those other embodiments are to be considered as included within the scope of this invention.

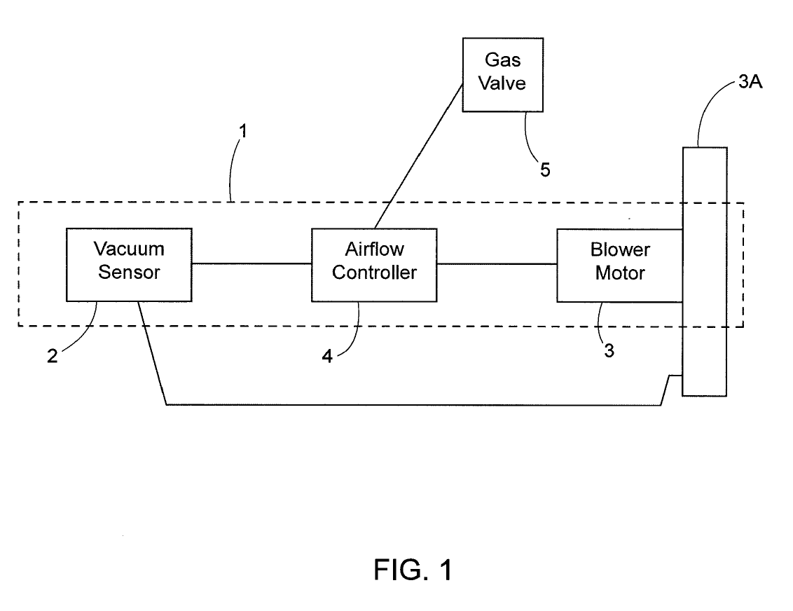

FIG. 1 illustrates a block diagram of the air flow control system 1 of the present invention. A vacuum (or pressure differential) sensor 2 senses the vacuum induced by a blower motor 3 within a blower housing 3A. An airflow controller 4 excites the vacuum sensor 2, extracts a suitable electronic feedback signal proportional to the sensed blower vacuum, and drives the blower motor at a speed as required to maintain a specific vacuum, thereby maintaining the blower output airflow constant. As explained below, should the sensed vacuum go beyond a preset limit, for a preset period of time, the control system 1 will shut off the gas valve 5, to thereby shut down the HVAC system as a safety feature.

### A. Vacuum Sensor

The vacuum sensor 2 used in the preferred embodiment of the airflow control system 1 is preferably a modified vacuum switch manufactured by Honeywell and provided under p/n CPXL04GF.

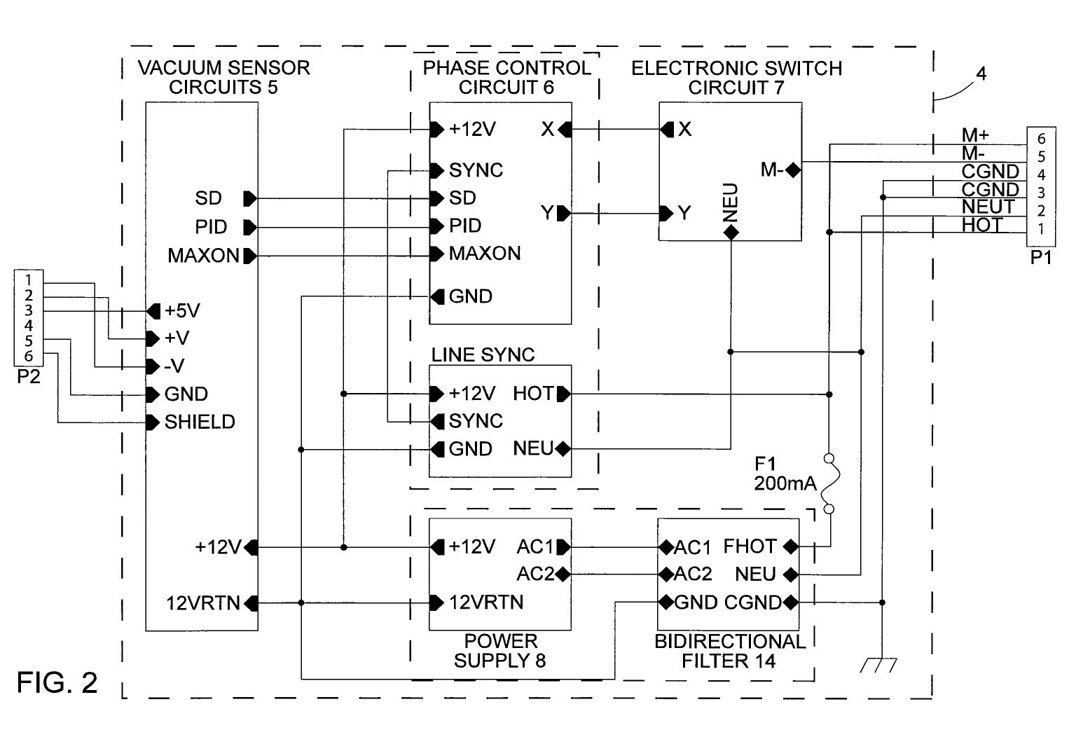

The vacuum sensor 2 typically contains no internal signal conditioning, is not compensated for temperature and/or output span or null (zero output), operates over a pressure range of +/−4 inches of water, and produces an output voltage swing of +/−17 mV per inch of water (+/−68 mV @+/−4 inches of water). Referring to FIG. 2, the sensor excitation voltage can be varied over a range of 3 to 16 VDC and is supplied by the airflow controller 4 across pins 3 (+V) and 5 (−V or ground) of the vacuum sensor connector P2. The sensor output to the controller 4 is taken from pins 2 (+Vout) and 1 (−Vout). Null offset is typically listed as 0 mV. Null shift with respect to temperature is listed as 2600 PPM per degree Celsius. Span shift with respect to temperature is listed as −1800 PPM per degree Celsius and Linearity and hysteresis error as +/−1% of full scale.

### B. Controller

FIG. 2 illustrates a more detailed block diagram of the preferred embodiment of the present invention where the controller 4 is comprised of vacuum sensor circuits 5, a phase control circuit 6, an electronic switch circuit 7, and a power supply 8.

i. Vacuum Sensor Circuits

In the preferred embodiment, the vacuum sensor circuits 5 include a sensor excitation power supply 9, a high frequency noise filter 10, an amplifier circuit 11, and a vacuum regulator circuit 12.

(a) Sensor Excitation Power Supply

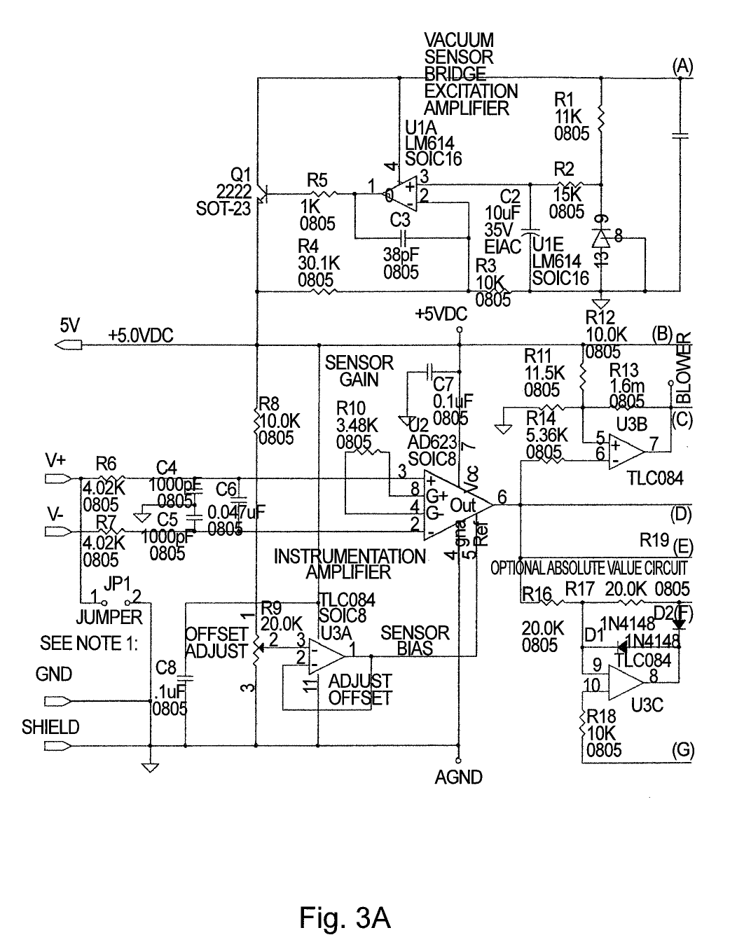

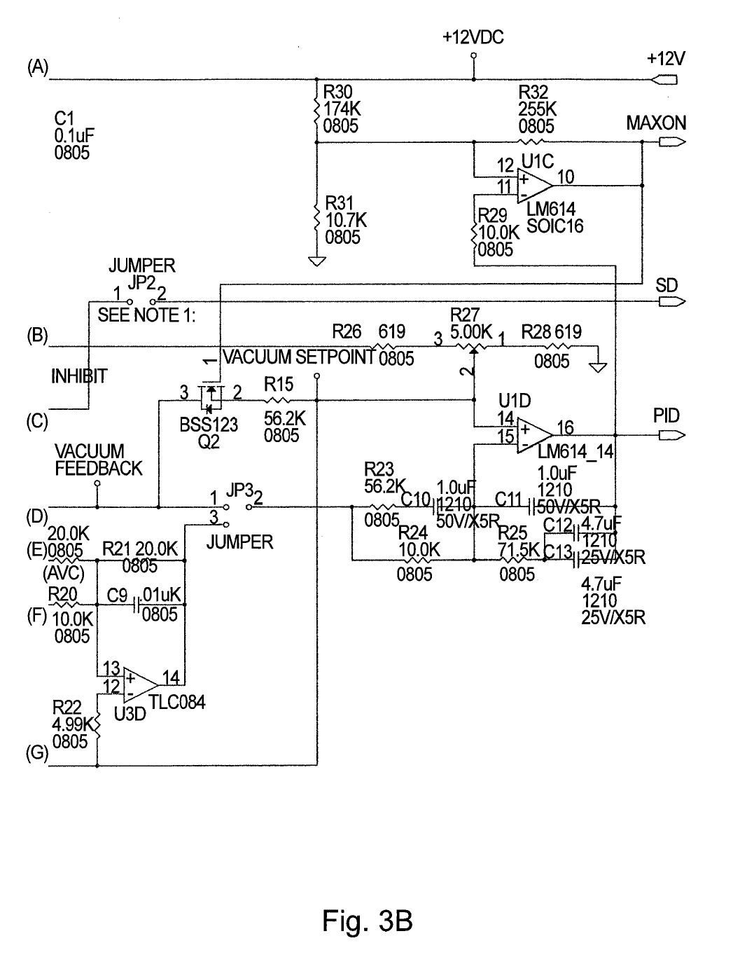

Because the vacuum sensor 2 produces a relatively small (10's of mV) full scale differential output signal, it is important that the circuits of the airflow controller 4 are free of noise that might otherwise tend to mask the vacuum sensor's 2 true output signal. In the particular circuit in FIG. 3, the sensor excitation power supply 9 is designed for 5.0 VDC and is implemented with a 1.225V precision voltage reference U1E, built into an LM614 type integrated circuit U1, which also contains four general-purpose operational amplifiers: U1A, U1B, U1C, and U1D. The precision reference U1E is biased using a resistor R1 and feeding the 1.225 reference voltage from U1E's cathode terminal to the positive input of operational amplifier U1A through a low pass filter consisting of resistor R2 and a capacitor C2.

Operational amplifier U1A, configured as a non-inverting amplifier with a gain of two set by feedback resistors R4 and R3, is used to produce a 5V excitation power supply whose output is measured from the emitter of an NPN transistor Q1 to ground. NPN transistor Q1 provides a current gain allowing the low noise excitation supply to drive a relatively large capacitive load. A resistor R5 is used to bias the output transistor and a capacitor C3 provides stability compensation.

(b) Amplifier Circuit

When the 5.0V sensor excitation power supply 9 is impressed across the supply terminals of the vacuum sensor 2, ideally the plus and minus signal outputs of the sensor will both be biased to ½ of the excitation supply (2.5V to ground), assuming the Wheatstone bridge is perfectly balanced and the blower motor 3 is perfectly at rest. As the blower motor 3 begins turning, a pressure will develop across the plus and minus terminals of the Wheatstone bridge causing the plus and minus outputs of the Wheatstone bridge to move apart. This causes a small differential voltage to develop between the plus and minus outputs that is proportional to vacuum displacement. A full scale change in output voltage of the vacuum sensor 2 is approximately 17 mV per inch of water change in pressure up to a maximum of 4 inches of water, or 68 mV full scale in either direction.

To be useful, the differential output voltage from the vacuum sensor 2 must be greatly amplified. An amplifier must reject the 2.5V common mode DC voltage measured from each output terminal to ground. Generally, this requires a difference amplifier that has the ability to reject a large common mode signal component. Amplifiers with this capability are commonly referred to as instrumentation amplifiers.

A discrete instrumentation amplifier can be built using multiple operational amplifiers, but can also be purchased in integrated form such as the AD623 integrated instrumentation amplifier U2 used in the preferred embodiment, as shown in FIG. 3. A single external gain control resistor R10 can be used to set the differential gain between 1 and 1000, single supply or bipolar supply operation, rail-to-rail output swing capability, and a virtual ground/offset control input which can be used to center the output of the amplifier to some DC potential above ground such as half of the 5.0V excitation supply for single supply applications.

The voltage output of the vacuum sensor 2, is applied to the plus terminal pin 3 and minus terminal pin 2 of the instrumentation amplifier U2 via a high frequency noise filter 10, consisting of resistors R6 and R7 and capacitors C4-C6. Instrumentation amplifier U2 amplifies the differential component of the vacuum sensor 2 output voltage while rejecting the 2.5 VDC common mode component present on both of the vacuum sensor 2 bridge output terminals due to the low noise 5V sensor excitation power supply 9.

The voltage gain (“Gv”) of the instrumentation amplifier U2 is set by resistor R10, which is connected across pins 1 and 8 of instrumentation amplifier U2. When the value of R10 is 3.48 Kohms, the voltage gain (GV=1+100K/R10) is approximately 30. The amplified differential output of instrumentation amplifier U2 is applied across its pins 5 and 6. Pin 5 of instrumentation amplifier U2 is normally biased to a positive voltage with respect to ground of between 2.5 and 3 volts. For the configuration of the preferred embodiment shown in FIG. 3, the differential output is negative and the output of the amplifier at pin 6 varies according to the equation Vbias−30*Vc, where Vbias is the voltage at instrumentation amplifier U2 pin 5 and Vc is the differential output of the vacuum sensor 2.

An idealized system, where zero vacuum is produced when the blower motor 3 is running and there are equal inlet and outlet restrictions, would be capable of driving the output of the instrumentation amplifier U2 at pin 6 between 0.5V, when the inlet of the blower was blocked, and 4.5V, when the outlet of the blower was blocked, assuming that pin 5 of instrumentation amplifier U2 was biased at 2.5, the amplifier voltage gain was set to 30, and a pressure of +/−4 inches of water was applied to the vacuum sensor 2 when blocking the respective inlet and outlet ports of the blower.

In a real system, the vacuum produced when the blower motor 3 is running is typically negative and the static inlet restriction is typically much greater than the outlet static restriction. Under these operating conditions, the vacuum displacement is much more sensitive when the blower outlet (versus the inlet) is blocked. In addition, the blower motor 3 is normally biased to operate somewhere near the full-load end of the torque/speed curve under static operating conditions. To compensate for these real system operating conditions, the bias applied to pin 5 of the instrumentation amplifier U2 is increased above 2.5V.

The following is an example of a system operating under real conditions where pin 5 of the instrumentation amplifier U2 is increased to 3V (the “bias setting”) to compensate for a negative static operating vacuum. With the blower motor 3 running the typical inlet and outlet restrictions, the differential output of the instrumentation amplifier U2 is approximately −1.2V producing an output at pin 6 relative to circuit ground of approximately 1.8V (3V−1.2V=1.8V). The static vacuum is thus 2.35 inches of water (−(−1.2/30)*(4/0.068)), where the final minus sign is due to the inverting connection of the instrumentation amplifier U2 The amplifier is inverted in order to present a negative feedback for the downstream vacuum regulator circuit 12.

Blocking the blower outlet causes the differential output of the instrumentation amplifier U2 to increase in a positive direction to a maximum of approximately −0.2 volts, causing the output of pin 6 relative to ground to swing to approximately 2.8V (3−0.2=2.8V), assuming that the vacuum regulator circuit 12 loop is open (otherwise the motor speed would be driven in a direction to drive the vacuum back towards the static operating point).

Similarly, blocking the blower inlet causes the differential output of the instrumentation amplifier U2 to decrease to a minimum of approximately −2.0V, causing the output of pin 6 relative to ground to decrease to 1V (3−2.0=1.0V), assuming that the vacuum regulator circuit 12 loop is open. As the inlet and outlet restrictions are varied, the respective plus and minus signal strengths vary significantly (due to variations in static restriction) but remain centered about the static setting. The static setting itself varies itself with the static, or unblocked, running speed of the blower.

The bias setting voltage applied to pin 5 of the instrumentation amplifier U2 is provided by a resistive divider, consisting of resistors R8 and R9, connected across the 5V power supply (applied to the instrumentation amplifier U2) via a unity gain amplifier U3A. Unity gain amplifier U3A provides low output impedance so that instrumentation amplifier U2 pin 5 will not load the bias setting. Resistor R9 can be adjusted as necessary to accommodate for a non-zero running vacuum, and (if necessary) to compensate for any inherent DC offset present in the bridge of the vacuum sensor 2.

(c) High Frequency Noise Filter

Instrumentation amplifiers rectify high frequency out-of-pass-band noise signals present at the amplifier's input terminals. Once rectified these signals appear as DC offset errors at the amplifier output. To avoid this problem in the preferred embodiment, the outputs of the vacuum sensor 2 are first applied to a high frequency noise filter 10 which filters from the signals the high frequency noise before the signals are applied to the instrumentation amplifier U2.

Referring to FIG. 3, the high frequency noise filter 10 consists of resistors R6 and R7 and capacitors C4, C5, and C6. The differential filter pole due to the resistor and capacitor combination of R6 and C4, and likewise to R7 and C5, is set to approximately 40 kHz in the preferred embodiment. Resistors R7 and R6 and capacitors C4 and C5 form a bridge circuit whose output appears across the instrumentation amplifier U2's input terminals. Any mismatch between capacitors C4 and C5 will unbalance the bridge and reduce common mode rejection. Capacitor C6 is needed to maintain common mode rejection low frequencies and insures that any RF signals are common mode (the same on both input terminals) and not applied differentially. The second low-pass network consisting of resistors R7 and R6 and capacitor C6 has a filter pole at approximately 400 Hz.

(d) Vacuum Regulator Circuit

The vacuum regulator circuit 12 of the preferred embodiment is a closed-loop proportional-plus-derivative discrete circuit voltage regulator which serves to regulate or maintain a constant set point vacuum regardless of load disturbances on the system. The vacuum regulator circuit 12 is of conventional design and its form and function will be recognized by those skilled in the art of feedback systems. Referring to FIG. 3, the vacuum regulator circuit 12 of the preferred embodiment is implemented with a single operational amplifier, U1D, and discrete resistors and capacitors, R23-28 and C10-C13. The purpose of the regulator is to automatically maintain a specific operating vacuum by adjusting the blower motor's 3 speed in a direction which minimizes the difference (or vacuum error) between a command voltage representing the desired or set point vacuum and a feedback voltage which is proportional to the actual or measured vacuum.

The vacuum regulator circuit 12 generates an output voltage of desired polarity and magnitude that causes the phase control circuit 6 to vary the firing angle of the electronic switch circuit 7. The firing angle of the electric switch circuit 7 controls the average AC voltage applied across the blower motor 3. Increasing the average voltage applied to the blower motor 3 causes it to accelerate at a higher speed. Decreasing the applied AC voltage causes the blower motor 3 to decelerate or simply to coast down to a lower speed. A change in blower speed causes a variation in vacuum that is sensed by the vacuum sensor 2.

In a nutshell, the magnitude of the change in voltage generated by the vacuum regulator circuit 12 is designed to produce a change in vacuum which exactly matches the change in vacuum caused by a corresponding change in load induced by blocking or restricting the blower motor's 3 inlet or outlet ports. The polarity of the change in the output voltage of the vacuum regulator circuit 12 opposes the polarity of the change in vacuum induced by loading or blocking the inlet and/or outlet ports of the blower motor 3. The vacuum regulator circuit 12 thus acts to maintain a specific system vacuum in a closed load manner by countering or opposing changes in vacuum due to variation in load. Because airflow is essentially directly proportional to vacuum over the limited operating range of the blower motor 3, regulating or maintaining a specific vacuum also maintains a specific rate of airflow through the blower.

The inputs to the vacuum regular circuit 12 are a vacuum set point voltage that is proportional to the desired or set point vacuum and a vacuum feedback voltage that is proportional to the vacuum measured by the vacuum sensor 2.

Referring to FIG. 3, the vacuum set point voltage is generated with a voltage divider consisting of two fixed resistors, R26 and R28, and a variable resistor, R27, connected across the 5V sensor excitation power supply 5 and ground. The vacuum set point voltage is taken from the wiper terminal of R27 and is connected to pin 14 of operational amplifier U1D. Varying the wiper position of resistor R27 varies the vacuum set point voltage over a range of approximately 1 to 4 Volts.

The vacuum feedback voltage of the vacuum regulator circuit 12 is taken from the output of the instrumentation amplifier U2 at pin 6. To close the vacuum control loop, the vacuum feedback voltage is applied to the inverting or negative terminal of the vacuum regulator circuit 12 at pin 15 of operational amplifier U1D via an RC input impedance formed by resistor R24 connected in parallel with the series combination of resistor R23 and capacitor C10.

The output of the vacuum regulator circuit 12 is taken from pin 16 of amplifier U1D. The gain of the vacuum regulator circuit 8 is defined by the ratio of the feedback impedance (Zf) connected between the output of operational amplifier U1D at pin 16 and the negative input signal of U1D at pin 15 and the input impedance (Zi) connected between the feedback input signal and the negative input of amplifier U1D at pin 15. The output of the vacuum regulator circuit 12, as a function of ratio of feedback and input impedance and its two inputs, is Vo=(Zf/Zi)*(Vsp−Vfb)+Vsp, where Vsp is the vacuum set point voltage and Vfb is the vacuum feedback signal. The difference voltage (Vsp−Vfb) represents vacuum error.

The regulator gain, defined by the ratio of Zf/Zi, varies with frequency and in general includes three separate gain terms which are commonly referred to as proportional gain (Kp), integral gain (Ki) and derivative gain (Kd). Proportional gain Kp varies the output of the vacuum regulator circuit 12 in direct proportion to vacuum error or the difference between the vacuum set point voltage and the vacuum feedback voltage (Vo˜Kp*(Vsp−Vfb)). This gain term acts to minimize the vacuum error but cannot reduce it to zero.

The integral gain term Ki adjusts the output of the vacuum regulator circuit 12 until the vacuum error is exactly zero (Vo˜(Ki/s)*(Vsp−Vfb)). The derivative gain term Kd adjusts the output of the vacuum regulator circuit 12 due to changes in vacuum error proportional to the equation Vo˜(Kd*s)*(Vsp−Vfb). The derivative gain term Kd is proportional to the rate of change in vacuum error and acts to prevent over or under shooting the vacuum set point. Working together the three gain terms control the time response of the regulator so that the output of the vacuum regulator circuit 12 is smoothly adjusted in the correct direction and magnitude to maintain the desired set point vacuum.

The output of the vacuum regulator circuit is capable of swinging from approximately 0.6V minimum to approximately 11.4V maximum. The output pin 16 of operational amplifier U1D is connected to the input of the phase control circuit 6, which controls the average voltage applied by the electronic switch circuit 7 to the blower motor 3. The maximum output of the vacuum regulator circuit 8 corresponds to the minimum or full-load motor speed. The minimum output of the vacuum regulator circuit 12 corresponds to the maximum motor speed as described in further detail below.

ii. Electronic Switch Circuit

The electronic switch circuit 7 operates as a conventional phase-controlled electronic switch to modulate the average AC voltage applied across the AC terminals of a blower motor 3. Modulating the voltage applied to the blower motor 3 controls its running speed. The speed control is not infinitely variable when the blower motor is a shaded pole AC motor. Instead it is constrained to modulate the blower voltage and resulting speed over a relatively narrow speed control range associated with the linear portion of the single phase AC motor's speed torque curve. In this particular embodiment of the airflow controller 4 the obtainable airflow control range is thus limited by motor design issues related to the motor's pole count, the fixed line frequency, the line voltage, and rotor air gap.

A designer skilled in the art will recognize that the same vacuum feedback based airflow control technique could be applied to more powerful motors (such as poly-phase AC induction, DC, brush-less DC, or switched reluctance motors) featuring a larger speed control range and/or an alternate method of voltage or torque variation (variable voltage, variable frequency, variable current/torque and pulse width modulation versus linear control techniques) to achieve a larger motor speed control range and thus a wider airflow control range.

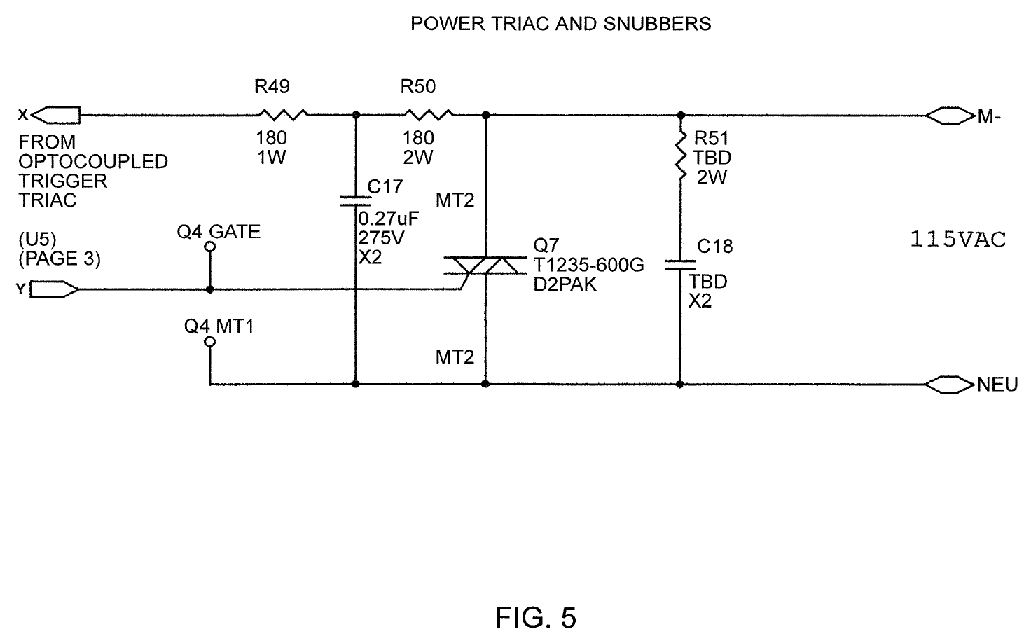

Referring to FIG. 2, the blower motor 3 is wired in series with the electronic switch circuit 7 through motor connector P1. The average AC voltage applied to the motor is controlled by modulating the firing angle of the of the electronic switch circuit 7 in synchronism with the AC line frequency. Referring to FIG. 5, this is accomplished by applying a suitable firing pulse across the low-level gate-to-MT1 control terminals of the electronic switch circuit 7 once per ½ line cycle of the AC line voltage.

Modulating the firing angle of the electronic switch circuit 7 (which, once fired during a given line cycle, functions as a simple AC switch until commutated off as the motor current crosses zero in the succeeding line cycle) controls how much of the available line voltage in a given line cycle is applied to the blower motor 3. If the electronic switch circuit 7 is switched immediately following an AC line crossing, the full AC line voltage is applied to the blower motor 3 during the succeeding 180 degrees of the next ½ line cycle. If the firing angle is delayed with respect to the line voltage crossing, only a portion of the available sinusoidal voltage line cycle is actually applied to the motor. If the firing angle is delayed 180 degrees, the electronic switch circuit 7 never turns on and no voltage is applied to the motor in the succeeding cycle.

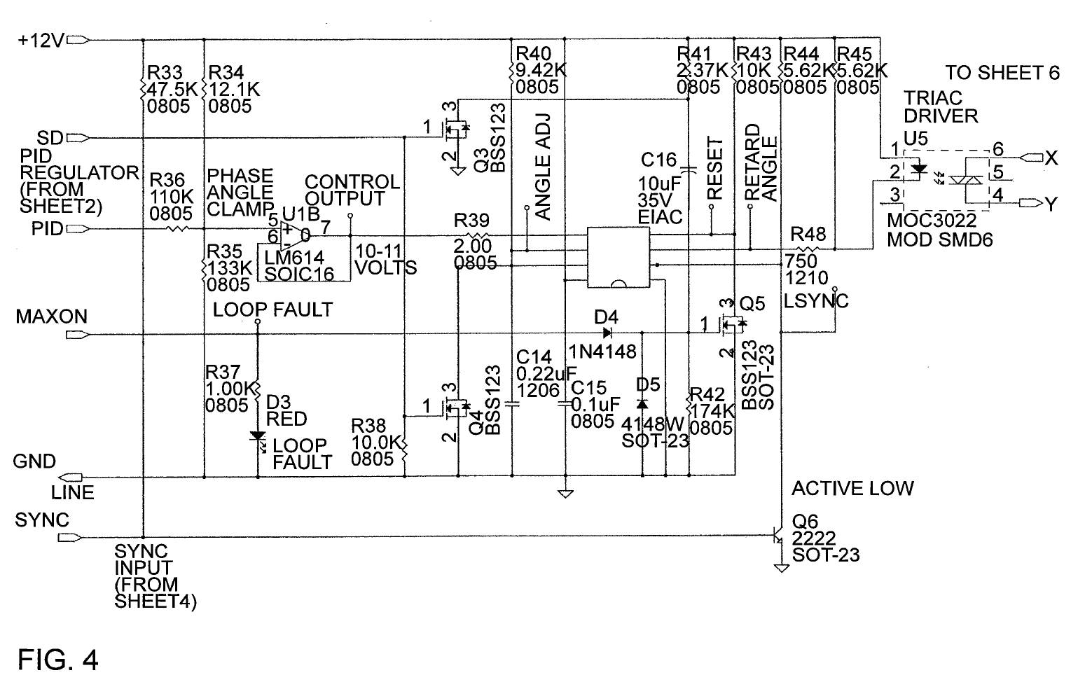

Referring to FIG. 4, the gate control terminal Y of the electronic switch circuit 7 is connected to pin 4 of a light activated (or optical) integrated circuit U5 of the phase control circuit 6. Terminal X of the electronic switch circuit 7 is connected to pin 6 of the integrated circuit U5. The output of phase control circuit 6 controls the light emitting diode in the integrated circuit U5, which controls the firing angle of the electronic switch circuit 7 in order to modulate the effective or average voltage applied to the blower motor 3. The optical nature of the integrated circuit U5 serves to decouple or electrically isolate the low-level airflow control logic from the high-voltage, high-current, electronic switch circuit 10.

Referring to FIG. 5, resistor R49 in the electronic switch circuit 7 controls the magnitude of the AC gating current forced through the gate-to-MT1 terminal when it is fired or gated on. The required triggering current varies with the size of the electronic switch circuit 7 required to control a given motor and thus varies with the size of the motor. Resistor R50 and capacitor C17 limit the rate of rise of voltage reapplied across the electronic switch circuit when the integrated circuit U5 and the electronic switch circuit 7 turn off. This prevents the electronic switch circuit 7 from being turned back on unintentionally via parasitic capacitance paths within the electronic switch circuit 7 and the integrated circuit U5. In most applications snubber components resistor R50 and capacitor C17 provide sufficient dv/dt snubbing to prevent turn on due to reapplied dv/dt for both the integrated circuit U5 and the electronic switch circuit 7. In more demanding applications an optional RC snubber (resistor R51 and capacitor C18) can be added to the circuit to provide enhanced dv/dt protection.

iii. Phase Control Circuit

The phase control circuit of the preferred embodiment is of conventional design and consists of an integrated circuit RC timer U4 and an AC line zero crossing detection circuit 13. The RC timer U4 is used to produce a gating pulse for electronic switch circuit 7 that can be positioned anywhere within the 0-180 degree half line cycle period of the AC line. The AC line zero crossing detection circuit 13 is used to provide a synchronizing pulse to precisely align the output of the electronic switch circuit 7 between successive AC line zero crossings.

(a) AC Line Zero Crossing Circuit

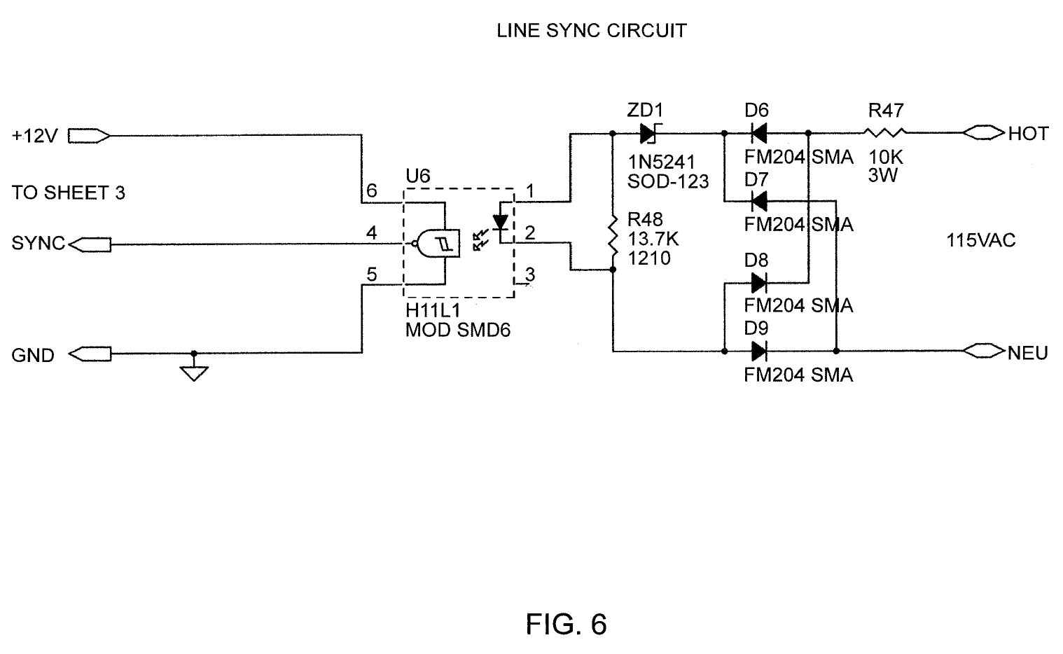

Referring to FIG. 6, the AC line side of the AC Zero Crossing Circuit 13 includes a full wave rectifier D6-D9, a current limiting resistor R47, a zenor diode ZD1, a second resistor R48, and an open-collector, inverting Schmitt-triggered, logic output, integrated circuit optocoupler U6 (“optocoupler U6”). Current limiting resistor R47 establishes a current sufficient to trigger the optocoupler U6 logic output at pin 4 low when the line voltage exceeds a minimum voltage established by the sum or the voltage drops across zenor diode ZD1, the full wave rectifier D6-D9, and the resistor R48. Resistor R48 provides a small bias current that insures the zenor diode ZD1 operates in the linear portion of its clamping characteristic above the zenor knee voltage. Resistor R48 also facilitates on/off switching of the optocoupler U6 LED by providing a path for leakage currents.

The output of the optocoupler U6 at pin 4 is connected to the phase control circuit 6 where it drives the base of a small-signal NPN transistor Q6, as shown on FIG. 4. Resistor R33 (connected from the base of NPN transistor Q6 to +12V) serves as a pull-up for the synchronization signal. NPN transistor Q6 inverts the line crossing signal to provide an active low synchronization pulse that is applied to the junction of pull-up resistor R44 and pin 2 of RC timer U4. The active low synchronization pulse is approximately 715 microseconds wide (7.74 degrees) at the nominal value (115 VACRMS) of the AC line voltage and is centered on the AC line zero crossing event.

(b) RC Timer and Control Logic

Referring to FIG. 4, the phase control logic for the phase control circuit 6 is based on a general-purpose industry standard 555 timer integrated circuit U4 and is used to generate one firing pulse per half line cycle for the electronic switch circuit 7. The RC timer U4 is configured as a re-triggerable one shot timer that is controlled by an external voltage applied to its voltage control pin 5. The voltage at pin 5 is established by a 3-terminal resistive voltage divider consisting of resistors R34, R35, and R36 whose output is applied to RC timer U4 through a unity gain buffer amplifier U1B. Unity gain buffer amplifier U1B serves as a voltage buffer and impedance translator. It simultaneously presents high input load impedance to the divider (which has high output impedance) and low output impedance to the RC timer's U4 voltage control pin 5. In this configuration, the RC timer U4 (which has relatively low impedance) does not significantly affect the diver voltage through loading.

Resistor R34 of the 3-terminal voltage divider is connected to the +12V logic supply. Resistor R35 is connected to logic ground. Resistor R36 is connected to the output of the vacuum regulator circuit 12 at operational amplifier U1D pin 16. The voltage applied to the RC timer's U4 voltage control pin 5 is the sum of a DC bias term and a signal proportional to the output of the vacuum regulator circuit 12 and can be calculated using the formula:

$${v}_{U 4 pin 5} := \frac{[ {V}_{CC} \cdot {R}_{35} \cdot {R}_{36} + V ( U 1 D , Pin 16 ) \cdot {R}_{34} \cdot {R}_{35} ]}{( {R}_{34} \cdot {R}_{35} + {R}_{34} \cdot {R}_{36} + {R}_{35} \cdot {R}_{36} )}$$

When the output of the vacuum regulator circuit 12 V(U1D, pin16)=0, the phase control circuit 6 produces a firing angle for the electronic switch circuit 7 that drives the blower motor 3 to the upper end of its speed torque curve (maximum speed). When the output of the vacuum regulator circuit 12 is at its maximum value (approximately 11.4V), the phase control circuit 6 produces a firing angle for the electronic switch circuit 7 that drives the blower motor 3 to the lower end of its speed torque curve (minimum speed). The control logic for the phase control circuit 6 thus allows the output of the vacuum regulator circuit 12 to vary the blower speed over the full working range of the blower motor 3 through a variation in the electronic switch circuit's 7 firing angle.

The change in the firing angle (θmax−θmin) of the electronic switch circuit 7 required to produce a desired speed change in the blower motor 3 is related to the change in time (Dt) between the two firing angles through the formula Dt=Δθ/ω=(θ2−θ1)/ω, where ω=2*π*f and f is the applied line frequency. The change in time (Dt) relative to the synchronizing pulse is related to the RC timer's U4 RC time constant (set by resistor R40 and capacitor C14) through the formula: Dt=RCtimeconstant X natural logarithm(1−(VU4,pin5)/VCC), where VU4,pin5 is the effective control voltage input for the RC Timer U4 at pin 5 and VCC is the value of the fixed 12V supply voltage which powers the circuit. Thus for a known variation of the control voltage input of RC Timer U4, the values of resistor R40 and capacitor C14 can be selected to adjust the firing angle of the electronic switch circuit 7 to produce a given range in blower speed.

The output of the RC Timer U4 at pin 3 is connected to the cathode end of the input of the light emitting diode of the integrated circuit U5 via a current limiting resistor R46. The anode of the light emitting diode of integrated circuit U5 is connected to the +12V logic supply rail, VCC. Forcing a current through the light emitting diode of the integrated circuit U5 causes it to emit light, which in turn activates the light-sensitive trigger of the integrate circuit U5 and produces a gating signal for electronic switch Q7 of the electronic switch circuit (see FIG. 5). Gating the electronic switch Q7 applies an average line voltage and a current to the blower motor 3 that controls the blower motor's 3 speed as a function of the phase control circuit's 6 firing angle and the output of the vacuum regulator circuit 12.

Specifically the integrated circuit U5 and electronic switch Q7 are gated on when the RC Timer U4 output at pin 3 transitions low, causing a current to flow from the +12V logic supply rail VCC through the integrated circuit's U5 light emitting diode, current limiting resistor R46 and pin 3 of the RC Timer U4 to ground. The current flowing through the integrated circuit U5 is controlled by the value of resistor R46. An additional resistor R45 facilitates on-off switching of the light emitting diode by providing a path for leakage current around the LED.

The output of RC Timer U4 pin 3 is initially driven high by the active-low synchronization pulse applied to the RC Timer U4 trigger pin 2 by the AC line zero crossing circuit 13. At the same time the junction of resistor R40 and capacitor C14 is released via RC Timer U4 so that voltage at the junction can begin charging toward VCC. The RC Timer U4 output at pin 3 transitions low when the voltage at the junction of resistor R40 and capacitor C14 reaches the trip threshold of the timer (the control voltage at pin 5 of the RC Timer U5). When this occurs the RC Timer U4 output voltage is latched low and remains low until the next synchronization pulse is received from the AC line zero crossing detection circuit 13.

Once triggered by the high-to-low transistor at the RC Timer's U4 output pin 3, the electronic switch circuit 7 latches into conduction and remains latched on until the current in the motor crosses zero and commutates the electronic switch circuit 7 off (the latch referred to in this case is a function of the electronic switch's Q7 PNP/NPN semiconductor junction characteristic, as opposed to any physical latch associated with the firing circuit). Since the motor contains significant inductance, the motor current lags the applied voltage and the electronic switch Q7 does not actually turn off in the same AC half cycle as it was turned on. This does not create a synchronization problem for the firing circuit because the output voltage of the RC Timer U4 at pin 3 returns high on the next high-to-low transition of the synchronization pulse from the AC line zero crossing circuit 13, thus commanding the integrated circuit U5 of the phase control circuit 6 off. This occurs well before the motor current crosses zero.

In addition, the DC bias provided by the 3 terminal divider of resistors R34-36 establishes a minimum firing angle that is greater than the lag angle associated with the motor current zero crossing. Referring to FIG. 5, the moment the electronic circuit Q7 fires, the voltage across the MT2-to-MT1 terminal collapses to less than 1V. This in turn removes the line voltage input to the integrated circuit U5 pin 6 such that there is insufficient voltage to source current into the electronic switch's Q7 gate terminal regardless of whether the current into the light emitting diode side of the integrated circuit U5 is still present or not. The net result is that the next firing pulse occurs after the electronic switch Q7 has turned off, thus insuring that the phase control circuit 6 can control the average voltage applied across the blower motor 3.

If the electronic switch circuit 7 is being commanded fully on by the upstream control logic, the RC Timer U4 output at pin 3 will have an infinitely small duty cycle (the output will remain low over the full line cycle) and the integrated circuit U5 will trigger the electronic switch Q7 back on instantly as the electronic switch circuit's 7 voltage attempts to recover following a motor current zero crossing.

iv. Power Supply

The preferred circuit for supplying power for the control logic of the airflow controller 4 is a +12 VDC logic level supply that draws a maximum load current of approximately 20 mA. In order for the control to be self-contained it is desirable to derive the necessary power from the same AC line that is used to power the blower motor 3.

(a) AC/DC Converter

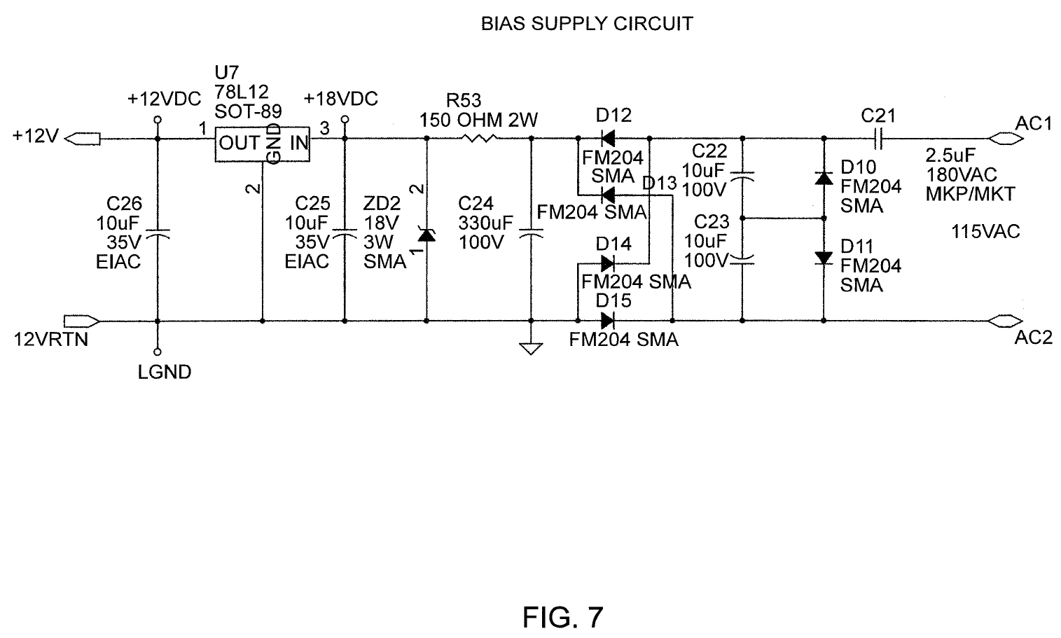

Referring to FIGS. 2 and 7, the power supply 8 used in the preferred embodiment is of conventional design and is based on a non-isolated capacitive fed, voltage step-down, single-phase, AC/DC rectifier circuit, which serves to convert 115 VACRMS line power to a uni-polar DC supply of 12V. Power Supply 8 provides +12V DC at its output and is capable of delivering a load current of 30 mA. Because the power supply 8 is not isolated from the AC line, the vacuum sensor 2 must be isolated from chassis ground or any other ground that the sensor may otherwise be placed in contact with.

Referring to FIG. 7, capacitor C21 is a 180V AC line rated film capacitor. Capacitors C22 and C23 are 100 VDC polarized aluminum electric capacitors which are connected back-to-back and shunted by diodes D10 and D11, which serve to clamp the reverser voltage applied across the capacitors during alternate line cycles to harmless levels (˜0.6 V). This configuration effectively converts the series capacitor string of C22 and C23 into an AC capacitor with an effective capacitance value of ½ the value of any one of the two equal value capacitors, or in this case, to a 5 uF AC capacitor. In such a configuration an AC capacitance value is attained at a cost and size considerably less than that of a comparable AC film capacitor of the same capacity.

Capacitor C21 and the effective capacitance of C22 and C23 located on the AC line side of the full wave rectifier D12-D15 form a capacitive voltage divider which serves to level shift the 115 VAC line voltage down to approximately 24 VAC at the AC input terminals of the full wave rectifier D12-D15. Capacitor C24, located on the DC side of the rectifier, is charged to the peak of the stepped-down AC line potential via full wave rectifier D12-D15 near the AC line peaks (when the input voltage exceeds the average DC potential stored on C24) and is partially discharged by the downstream load when the AC line dips below the average DC potential stored on capacitor C24 and the full wave rectifier D12-D15 is biased off.

The voltage on capacitor C24 is a DC voltage with a small 120 Hz ripple component (with an amplitude of approximately 10% of the stepped down line voltage) due to the on/off switching action of the full wave rectifier D12-D15. The maximum voltage of capacitor C24 is clamped by a resistor/zenor diode pre-regulator R53/ZD2, which presents a continuous load on capacitor C24. The load on capacitor C24 due to resistor/zenor diode pre-regulator R53/ZD2 considerably improves the load regulation of the low wattage voltage step-down AC/DC power supply 15.

The output of the resistor/zenor diode pre-regulator R53/ZD2 is 18V DC with respect to ground and is fed to a conventional three terminal integrated circuit voltage regulator U7 which serves to tightly maintain or regulate the output voltage (taken from pin 1 of voltage regulator U7) at +12V DC (+/−1-2%), regardless of line and load variations acting on the circuit. For the component values shown in FIG. 7, the power supply 8 delivers +12V DC to power the airflow logic control circuits (as shown in FIG. 2) for load currents up to approximately 30 mA as the AC line voltage varies from roughly 85 VAC to 135 VAC. The power supply 8 has a relatively poor leading input power factor but this is rendered inconsequential due to the much greater lagging power factor presented by the AC induction blower motor 3 operating on the same line.

(b) Bi-Directional Input Filter

In order to meet basic electrical safety regulations and basic Electromagnetic Interference compatibility requirements for equipment operating on an AC utility line, a bi-directional input filter 14 is connected between the power supply 8 and the AC line. The bi-directional input filter 14 serves to prevent unwanted electrical interference generated by external sources operating on the same AC line from effecting the operation of the airflow controller 4 and also prevents any electrical interference generated by the airflow controller from being injected into the AC line.

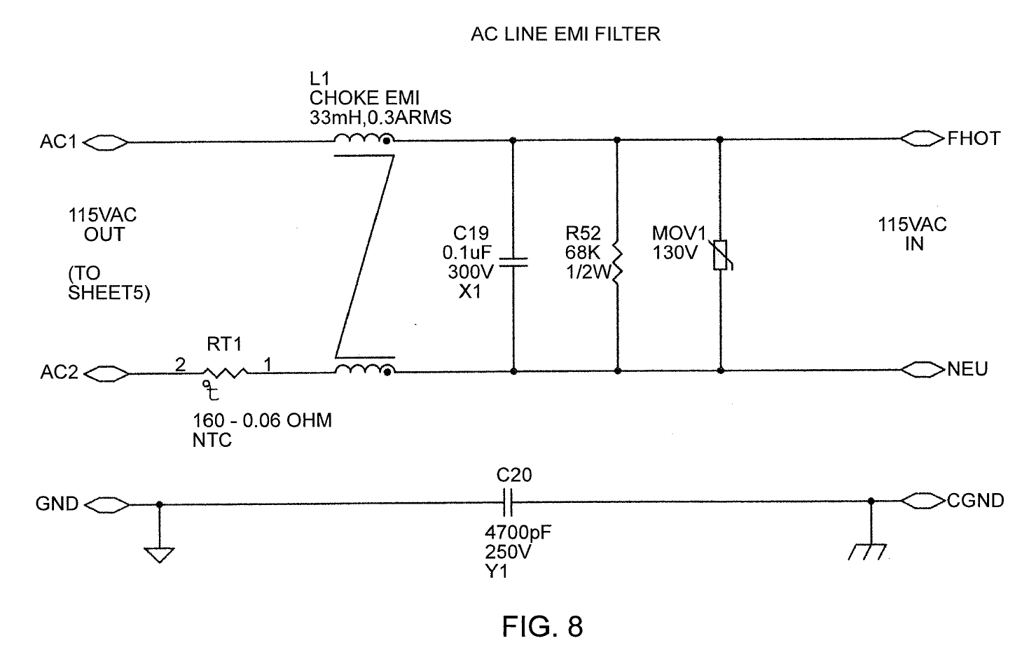

Referring to FIG. 2, a fuse F1 isolates the control circuit from the AC line if a catastrophic fault (such as an output short) occurs in the downstream circuitry. Referring to FIG. 8, a metal oxide varistor MOV1 serves to clamp voltage spikes commonly induced into AC power lines during lightning strike activity and/or spikes generated by other equipment operating on the same AC line. A surge limit thermistor RT1 limits inrush current into the power supply 8 during power up cycles. A resistor R52 discharges the input capacitors following power removal.

v. Start Up Circuit

The airflow controller 4 of the preferred embodiment is compatible with a variety of single-phase AC motors. Generally, single-phase AC motors, and single-phase shaded-pole AC motors in particular, have limited starting torque. To insure that the motor will start, the phase control circuit 6 is temporarily overridden and electric switch Q7 is gated fully on for the first several seconds following the application of circuit power. This applies the maximum available AC line voltage across the blower motor 3 to help get it started and is accomplished with start-up timing circuit 15 components resistors R41-43, capacitor C16, diode D5, and small-signal MOSFET transistor Q5, as shown in FIG. 4.

When power is initially applied to the phase control circuit 6, resistor R41, timing capacitor C16 (which is initially discharged to zero volts), and resistor R42 cause the gate-to-source voltage of small-signal MOSFET transistor Q5 to pull up to the 12V logic supply rail. The drain of small-signal MOSFET transistor Q5, connected to the junction of pull-up resistor R43 and pin 4 of RC Timer U4, is driven low by the initial positive pulse at the gate of Q5 during power up. Pin 4 of RC Timer U4 is the timer's RESET input. When this pin is pulled low, all timing inputs to the RC Timer U4 are overridden and the timer output at pin 3 is driven low and is held continuously low until the RESET pin is returned high. Because a low signal at pin 3 gates the integrated circuit U5 on, the electronic switch circuit 10 will be latched fully on and will remain fully on until small-signal MOSFET transistor Q5 turns off and the RC Timer's U4 RESET pin returns high.

When logic power is applied to the airflow controller 4, the voltage on the gate of small-signal MOSFET transistor Q5 is immediately driven high. This voltage begins to fall exponentially towards zero volts as capacitor C16 (which was initially discharged to zero volts) charges towards the power supply voltage through resistors R41 and R42. Small-signal MOSFET transistor Q5 will turn off when the gate-to-source voltage of Q5 falls to approximately 1V. The period during which the phase control circuit 6 is overridden is proportional to the time constant of (R41+R42)*C15.

When small-signal MOSFET transistor Q5 turns off, the phase control circuit 6 will assume control of the electronic switch circuit's 7 firing angle via RC Timer U4 and integrated circuit U5. Diode D5, connected in parallel with resistor R42 provides a rapid (low impedance) discharge path around resistor R42 when power is removed from the circuit, insuring that the RC Timer U4 is reset to zero before the next power-on event occurs. The purpose of resistor R41 is to allow the RC Timer's U4 RESET mechanism to be overridden when input SD is pulled low so that the start-up sequence can be optionally synchronized to an external event (such as the feedback voltage exceeding a pre-determined operating threshold) versus a power-up transition. Timer input SD can be used when the airflow controller 4 is used in a system where airflow is controlled using temperature control as opposed to vacuum control. The gate of small-signal MOSFET transistor Q5 can also be driven high (placing the RC Timer U4 in reset mode and gating the electronic switch Q7 fully on) by the signal labeled MAXON, which is generated by a comparator circuit located in FIG. 4 and discussed in the following section.

vi. Vacuum Alarm Circuit

In an alternative embodiment, the airflow controller 4 can contain a vacuum alarm circuit 16 that alerts a user or HVAC technician that an abnormal blockage is present in the vent system. When the blower outlet is fully blocked, the output voltage of amplifier U1D of the vacuum regulator circuit 12 will saturate in the negative direction (U1D at pin 16 ˜0.6V). Referring to FIG. 3, operational amplifier U1C is configured as an inverting comparator with hysteresis and senses this condition. When the output of operational amplifier U1D is driven below approximately 0.7V, the output of operational amplifier U1C pin 10 is driven high. The high output of operational amplifier U1C forces the downstream phase control circuit 6 into a fully on condition. This applies the full line voltage across the blower motor 3 in an attempt to drive the blower speed to its maximum possible operating speed as a fail-safe mechanism.

Referring to FIG. 4, the output of operational amplifier U1C also drives light-emitting diode D3 via resistor R37 to provide a visual indication of this operating condition. The LED is intended to provide a field trouble shooting aid by providing a visual warning that the blower outlet is physically blocked, perhaps by a bird's next in the blower's vent pipe.

Referring to FIG. 3, the trip threshold of operational amplifier U1C is established by a voltage divider comprising resistors R30 and R31 connected between the 12V supply and ground and from the operational amplifier output to its positive input (and the junction of resistors R30 and R31) via resistor R32. Resistor R32 provides positive feedback from the operational amplifier output to establish a hysteresis band around the operational amplifier's U1C trip threshold set by resistors R30 and R31. The hysteresis insures that the operational amplifier U1C switches off-to-on and on-to-off cleanly and can be adjusted large enough to keep the vacuum regulator circuit 12 from switching into and out of saturation near the maximum vacuum load point of the regulator. The operational amplifier U1C output automatically returns low (and the alarm LED turns off) when the restriction (or blockage) is removed.

vii. Calibrating the Set Point Voltage of the Vacuum Regulator Circuit

With the instrumentation amplifier U2 output at pin 6 referenced to a variable positive potential (typically between 2.5 and 3 volts by adjusting variable resistor R9), the static operating position of the blower motor 3 (the position represented by the normal running speed of the motor with no externally applied air restrictions) establishes a “virtual” operating reference voltage for the vacuum regulator circuit 12. In example discussed in section B(i)(b), the virtual reference was established by setting pin 5 of the instrumentation amplifier U2 to 3V with the motor running (and with otherwise unrestricted inlet and outlet ports) which produced a vacuum feedback signal (measured from instrumentation amplifier U2 pin 6 to pin 5) of −1.2V.

The resulting virtual reference is then 3.0−1.2=+1.8V, which equals the amplified vacuum feedback signal at the desired set point vacuum, measured from instrumentation amplifier U2 pin 6 to ground (the actual setpoint vacuum in this example is −(−1.2/30)*(4/0.068))=2.35 inches of water). To calibrate the control loop for this specific vacuum, variable resistor R27 (which adjusts the vacuum set point) is adjusted until the command voltage at the positive input to the vacuum regulator circuit 12 (Vsp) equals the vacuum feedback signal voltage at the desired motor speed set point (Vfb), or for this example Vsp=Vfb=1.8V.

With the command voltage established as described above, the output of the vacuum regulator circuit 12 (which controls the firing angle of the electronic switch circuit 7, which in turn adjusts the voltage applied to the blower motor 3) will drive or position the blower speed to a desired running speed. Fine adjustments to resistors R9 and R27 will walk the blower speed up or down the blower motor's 3 speed/torque curve until the desired (unrestricted port) running speed and a desired vacuum and airflow rate is established for a particular blower application.

Once this is accomplished for a particular application, the variable resistors R9 and R27 can be replaced with fixed resistors. In a typical blower, the unrestricted port run speed is set near the full load end of the speed torque curve, especially if the static inlet air restriction for a given blower system is large. An example of a system having a large static inlet restriction would be a system in which the inlet air for the blower is drawn across an inlet side heat exchanger.

With the static position of the blower speed established, the set vacuum and set airflow (essentially directly proportional to vacuum) are established and the airflow controller 4 is now calibrated to maintain or regulate a given vacuum and airflow rate as the inlet and outlet ports of the blower are blocked. Restricting the inlet or outlet ports of the blower is akin to varying the load on the blower. As the outlet port is loaded or restricted, the outlet port cross-section area decreases causing the airflow rate (the product of air velocity and port cross sectional area) to decrease. This reduces the system vacuum and the vacuum sensor 2 feedback signal (measured from instrumentation amplifier U2 pin 6 to ground) increases relative to ground and to the 1.8V virtual reference that is proportional to set vacuum. This drives the output of the vacuum regulator circuit 12 in a negative direction and increases the voltage across the motor, thus increasing the motor speed in order to bring the airflow rate and the vacuum back towards the airflow/vacuum set point. If the air inlet is blocked, the same sequence of actions occur, but in the opposite direction, causing the motor speed to decrease in order to maintain the airflow/vacuum set point.

In some airflow handling systems, it is desirable that the airflow controller 4 responds only to outlet restrictions and/or provides a reverse action where the motor speed is increased and actually saturates the vacuum regulator circuit 12 in the opposite direction when the inlet port is blocked. This can be accomplished by fully blocking the inlet port during the set point calibration procedure described above. This causes the output of the vacuum regulator circuit 12 to essentially saturate in the positive direction at the desired set point. Once saturated in the positive direction, the controller will no longer be able to reduce motor speed below the set speed and thus will be incapable of regulating the vacuum when the inlet port is released and then re-blocked. Instead, the vacuum regulator circuit 12 will saturate at the operating point defined during calibration. The controller will still be capable of regulating the vacuum in the opposite direction (in response to a blocked outlet) as the natural control action drives the output of the vacuum regulator circuit 8 to maintain the vacuum constant.

viii. Absolute Value Circuit

Alternatively, an increase in blower speed when the inlet is blocked can be accomplished by inserting an absolute value circuit 17 into the sensor feedback path, as shown in FIG. 3. In this case, the absolute value circuit 17 forces the normal control action when the blower outlet is blocked, but reverses the polarity of the sensor feedback signal (relative to the virtual vacuum set point) when the blower inlet is blocked. This violates the normal affinity control laws that govern the operation of the airflow/vacuum system and causes the vacuum regulator to saturate in the negative direction. However, it also forces the blower motor 3 to its maximum speed operating point (as a fail-safe mechanism), which in this case is what is desired.

Placing a shunt between terminals 1 and 2 of JP3 normally defeats the absolute value circuit 17 (in this case the vacuum sensor 2 output is routed directly to the inverting input of the vacuum regulator circuit 12). To activate the absolute value circuit 17, the normal shunt between pins 1 and 3 of JP3 must be removed and reinstalled between pins 2 and 3 of JP3. When the restriction at the blower inlet is released, the system will return to normal operation. Blocking the blower outlet reduces the vacuum such that the vacuum feedback signal is always equal to or greater than the vacuum reference (Vsp) and thus is unaffected by the absolute value circuit 17.

The optional absolute value circuit 17 is a conventional, non-inverting, single supply, absolute value circuit composed of amplifiers U3C and U3D. The bias point of the absolute value circuit 17 is set equal to Vsp (the vacuum regulator set point voltage) by connecting Vsp to the positive inputs of both U3C and U3D via input current balancing resistors R18 and R22.

Amplifier U3C is configured as a precision rectifier. When the amplified vacuum signal at the output of instrumentation amplifier U2 pin 6 is driven transiently above the vacuum set point by a value of Vsp+ΔV, the output of amplifier U3C operates as an inverting amplifier. The output of amplifier U3C taken from the junction of resistor R17, anode of diode D2, and the left hand side of resistor R20 will be driven to Vsp−ΔV, or −ΔV with respect to the positive terminal of amplifier U3D. The output of the instrumentation amplifier U2 (in this case Vsp+ΔV with respect to ground) is also applied to the second input of amplifier U3D via input resistor R19. Because the positive pin of amplifier U3D is biased to Vsp, the effective voltage across resistor R19 is +ΔV. Amplifier U3D is configured as a basic inverting amplifier and its output (for the component values shown on FIG. 3) will be driven to Vo(U3D)=+ΔV*(R21/R19)−ΔV*(R21/R20)+Vsp, or to Vo(U3D)=Vsp+ΔV. A positive vacuum signal (with suspect to Vsp) thus passes through the absolute value circuit 17 unchanged.

When the amplified vacuum signal output from instrumentation amplifier U2 is less than Vsp by a value of −ΔV, the output of amplifier U3C will be high and diode D1 (located in the feedback network of U3C) will be biased on. In this case, the output of the amplifier U3C (again taken from the junction of R17, the anode of diode D2, and the left hand side of resistor R20) will be driven to +Vsp, or to zero volts with respect to the positive terminal of U3D. Meanwhile, the voltage on the left hand side of resistor R19 will be equal to Vsp−ΔV, or −ΔV with respect to the positive pin of amplifier U3D. In this case the output of the absolute value circuit 17 will be driven to Vo(U3D)=(0)*(R21/R20)+ΔV*(R22/R19)+Vsp=Vsp+ΔV. That is, the change in vacuum (−ΔV) caused by blocking the blower inlet is inverted to look like an increase in vacuum (+ΔV) as though the outlet were being blocked. This in turn causes the blower motor 3 to increase in speed as the inlet restriction is increased. As the speed is increased, the actual vacuum simply decreases even further, eventually driving the vacuum regulator circuit 12 into negative saturation and the blower to its maximum output speed when the inlet is blocked. When the inlet restriction is removed, the vacuum regulator circuit 8 returns to normal operation. It will maintain a specific vacuum only when the blower outlet is restricted.

### C. Variable Speed Controller

In the preferred embodiment described above, a simple DC bias is applied to align the phase control circuit's 6 output with the full-load to no-load operating points of a normally fixed speed motor to achieve variable speed control. This form of variable speed control has a very narrow operating range determined mainly by motor design parameters, which in turn limit the effective control range of the airflow controller 4.

In more demanding applications, the torque/speed characteristic of the motor itself can be manipulated to greatly increase the available operating speed control range of the blower motor 3. For induction motors, this type of speed control varies from open loop speed control techniques (in which both the amplitude and frequency of the voltage applied to the motor are varied at a constant Volts/Hertz ratio) to closed loop techniques (such as Space Vector control where the machine torque and flux producing components of the induction motor's stator current are separately controlled inside of (or in cascade with) an outer closed loop speed control) that vary the effective torque/speed characteristic of the motor in order to achieve a much wider operating speed range. Regardless of the technique applied, the basic shape of the torque speed curve is retained but can be varied up or down the speed axis of the motor's speed/torque curve as though there were an infinite number of speed/torque characteristic curves to choose from.

A designer skilled in the art of variable speed drives will note that the airflow controller 4 of this invention could simply be placed around (e.g. in cascade with) the speed control loop of a traditional single-phase or poly-phase variable speed induction motor drive (or other variable speed drives operating with other types of motors) to greatly increase the operating range of the vacuum/airflow control.

The foregoing description has been given as merely illustrative of the invention and should not be considered as limiting the invention in any way. Instead, the invention should be considered as including any equivalents as would be apparent to those of skill in the art, relying on the teachings contained herein. The invention is intended to be limited only by scope of the claims appended hereto, and their legal equivalents.

What is claimed is:

1. An airflow control system for controlling the flow of air produced by a blower, the blower comprising a blower motor mounted to drive the blower, the airflow system comprising a vacuum sensor for sensing the vacuum created by the blower as it operates, the vacuum sensor producing a variable signal in response to the vacuum sensed, a control connected to the vacuum sensor for receiving the variable signal, the control being connected to the blower motor to control its speed in response to the value of the variable signal and thereby control the flow of air produced by the blower.

2. The airflow control system of claim 1 further comprising a connection to a gas supply valve, the control system being configured to produce a signal to shut off the gas supply valve in response to the variable signal exceeding a preset limit.

3. The airflow control system of claim 1 wherein the control is configured to override the variable signal during blower start up.

4. The airflow control system of claim 1 wherein said blower motor is a single phase AC motor, and the blower comprises a combustion blower for an HVAC system.

5. The airflow control system of claim 1 wherein the control is configured to maintain a constant air flow as produced by the blower.

6. The airflow control system of claim 1 wherein the blower further comprises a blower wheel rotatably mounted within a blower housing, and wherein the vacuum sensor is mounted to the blower housing behind the blower wheel, thereby sensing the input side pressure of the blower.

7. The airflow control system of claim 6 wherein the blower motor is mounted to the blower housing and connected to drive the blower wheel within the blower housing.

8. The airflow control system of claim 7 wherein the control is a PID control.

9. The airflow control system of claim 1 wherein said vacuum sensor variable signal is the only signal used by the control to control blower speed.

10. A method for controlling the air flow produced by a blower comprising:
sensing a pressure differential created by the blower during operation,
providing a variable signal corresponding to the sensed pressure differential to a control, and
in response to the variable signal, controlling the speed of a motor driving the blower.

11. The method of claim 10 wherein sensing a pressure differential includes providing a vacuum sensor mounted to the blower to sense the input pressure.

12. The method of claim 11 wherein providing a variable signal includes providing a variable signal from the vacuum sensor.

13. The method of claim 12 wherein the motor comprises a single phase AC motor, and controlling the speed of the motor includes using only the variable signal as a feedback input.

14. The method of claim 13 wherein the blower provides the combustion air for an HVAC system.

15. The method of claim 10 wherein controlling the speed of the motor includes controlling the motor speed solely in response to the variable signal to maintain a constant air flow from the blower.

16. The method of claim 11 wherein the blower includes a blower wheel rotatably mounted within the blower, and wherein the vacuum sensor is mounted to sense the input pressure to the blower wheel.

17. The method of claim 10 wherein controlling the speed of the motor includes controlling the motor speed to maintain a constant air flow from the blower.
